(19) United States
(12) Patent Application Publication
(10) Pub. No.: US 2007/0282056 A1
(43) Pub. Date: Dec. 6, 2007

(54) Polyester Composition Comprising Polybutylene Terephthalate Resin

(76) Inventors: Ronald Michael Alexander Maria Schellekens, Bunde (NL); Gerard Hidde Werumeus Buning, Oirsbeek (NL); Luc Elza Florent Leemans, Kortessem (BE); Wouter Gabrielse, Maastricht (NL)

Correspondence Address: NIXON & VANDERHYE, PC, 901 NORTH GLEBE ROAD, 11TH FLOOR, ARLINGTON, VA, 22203, US

(21) Appl. No.: 11/631,012

(22) PCT Filed: Jun. 22, 2005
(86) PCT No.: PCT/EP05/06754

§ 371 Date: Apr. 9, 2007

(30) Foreign Application Priority Data
Jul. 1, 2004 (EP) 04076896.2

(51) Int. Cl. C08G 63/183; C08L 67/00; C08L 67/03; G02B 1/04

(52) U.S. Cl. 524/556; 525/90; 525/93

(57) ABSTRACT

The invention relates to a polyester composition for use in mirror optic systems such as headlights for motor vehicles and reflector lamps comprising energy saving lamps, comprising a polybutylene terephthalate resin (PBT) and having a cyclic dimer content of less than 0.35 wt. %, relative to the weight of the PBT, and which composition further comprises a second polymer selected from the group consisting of polyethyleneglycol terephthalate (PET), PET copolymers, polybutylene naphthanate (PBN), PBN-copolymers, polytrimethylene terephthalate (PTT), PTT-copolymers, polyethyleneglycolnaphthanate (PEN), PEN-copolymers, polycyclohexanedimethylene terephthalate (PCT), PCT-copolymers, aromatic polycarbonates and aromatic polyester carbonates (APEC), in an amount of 1-40 wt. %, relative to the total weight of PBT and the second polymer. The invention also relates to a process for preparing the composition, use of the composition for making moulded parts and to a moulded part made of the composition.

The invention relates to a polyester composition comprising a polybutylene terephthalate resin (PBT), more particular to a polyester composition suitable for preparing moulded parts for use in mirror optic systems such as headlights for motor vehicles and reflector lamps comprising energy saving lamps.

Polyester compositions based on thermoplastic polyesters are widely used for preparing various moulded articles. Polymer compositions, based on other thermoplastic materials of different nature, are frequently used in headlights of cars to replace metal parts, initially only in less critical parts, such as the casing, but more and more also in more critical parts such as the bezel and the reflector. These latter parts require the use of high heat resistant materials. For these applications PBT comprising compositions are considered more and more as a real option. A problem, however, with PBT, like many other plastics, is that it gives rise to fogging when used in headlights for cars. Fogging is in the context of this application understood to be the deposition of volatile compounds, originating from the plastic composition and volatilised by the heating of the lamp under operating conditions, on cold spots such as the lens of the headlight. Measures applied to reduce fogging include, for example, exclusion of solvents in the composition; thinner designs for the moulded parts, thus reducing the amount of material contributing to fogging; and insulating the part by applying a coating. Another solution relates to special designs of the moulded part, or of the mirror optic system as a whole, as a result of which an internal air flow is induced when the vehicle is moving and the material contributing to fogging is guided away from the critical part, thus resulting in reduced deposition of the material contributing to fogging on that part. Fogging is undesirable because it reduces the transparency of the lens and reduces the yield of the light of the headlight. Moreover, it is aesthetically unattractive, since it takes away the clear view of a passant of a car on the nice and shiny look of the reflectors reflecting the advanced technology incorporated in the car.

The first object of the invention is to provide a polyester composition comprising a polybutylene terephthalate resin that intrinsically gives rise to reduced fogging when used in a part in a mirror optic system.

This object has been achieved with the polyester composition according to the invention, wherein the composition has a cyclic dimer content of less than 0.35 wt. % relative to the weight of the PBT.

In the context of the present invention “cyclic dimer” is understood to be the cyclic ester product of two butanediol units and two terephthalic acid units. It has been found by the inventors that the problem of fogging of PBT containing compositions is largely influenced by the cyclic dimer content in the PBT. The effect of the cyclic dimer content of less than 0.35 wt. % relative to the weight of PBT in the composition according to the invention is that the fogging problem is substantially reduced. When the inventive composition is used for the production of a moulded part for a mirror optic system, such as a bezel for a headlight of a car, the part gives rise to less fogging than a comparable part made of a composition comprising a standard PBT.

During the experimental work to arrive at the present invention it was observed that PBT prepared by a conventional melt polymerisation process generally comprises 0.45 wt. % or more cyclic dimer relative to the weight of the PBT. It has been found by the inventors that PBT having a cyclic dimer content of less than 0.35 wt. %, can be obtained by subjecting a PBT polymer obtained by melt polymerisation to a heat treatment step wherein the PBT is heated in solid form in an inert gas atmosphere to a temperature between 150° C. and the melting temperature of the PBT, and maintained at a temperature within 150° C. and said melting temperature for a time sufficiently long to attain the indicated low level of cyclic dimer content.

PBT compositions for use in headlamps are also described in JP2000198836A. The patent application relates to the problem of mould deposition occurring during moulding and surface quality of the resulting moulded product. This patent application describes PBT compositions with a butylene terephthalate oligomer content of less than 0.30 wt. %. This level was obtained by treating pellets of a PBT composition with water at a temperature of 80° C. followed by drying at 130° C. The nature of the oligomer concerned was not revealed. However, it has been found that this method does not lead to any significant reduction in cyclic dimer content, let alone to a cyclic dimer content of less than 0.35 wt. % relative to the weight of PBT.

It was also found by the inventors that use of the polyester composition, comprising a PBT with a cyclic dimer content of less than 0.35 wt. % prepared in the way described above, in an injection moulding process for the production of headlamp parts resulted in long moulding cycle times. More particularly, this occurred when moulds with a very high gloss surface were used, and/or where complicated mould design and mould geometries were used. Such high gloss surfaces are required to produce moulded parts with excellent surface quality, which can directly be metallized without the use of an intermediate coating layer. Though the conditions which resulted in the long cycle times can not be described in precise details and occurrence of this effect is hard to predict, the conditions can be generally addressed as critical moulding conditions. Where they occur, they result in an overall economically less favourable process, compared to situations where such problems do not occur. Thus, to make the process economically more favourable, the moulding cycle time had to be reduced. Therefore, inventors were faced with the problem of reducing the moulding cycle time.

In this respect it is noted that the moulding cycle time is not an absolute value, but depends on the specific process and process conditions that are applied for the production of a specific moulded part and on criteria set for such a process and product. Practically, the moulding cycle time can be defined as the minimum time needed to allow good demoulding behaviour and removal of a product from a mould with only limited or no deformation of the product, or as the minimum time that is needed to obtain a minimum percentage of approved products produced under the selected process conditions.

Patent application JP2003026786A relates also to a PBT composition and deals with the same problem. The solution provided in said patent application for said problem concerns blending of 2 PBT grades having different viscosities respectively below and above specific viscosity values. This solution is difficult to combine with the requirement of the low cyclic dimer content of the composition of the present invention, first of all because the viscosities have to be carefully controlled during the heat treatment step for achieving the low cyclic dimer content, either before or after the 2 PBT grades are mixed, and secondly because the PBT viscosity has also be tailored to obtain good moulding behaviour during the moulding process and to obtain good mechanical properties for the moulded part. Therefore there is the need for an alternative way of reducing the moulding cycle time for low fogging PBT compositions.

The second object of the invention is thus to provide a polyester composition comprising a polybutylene terephthalate resin with intrinsically low fogging properties that allows short moulding cycle times when used in an injection moulding processes involving critical conditions.

This object has been achieved with the PBT comprising composition according to the invention, which, next to a cyclic dimer content of less than 0.35 wt. %, relative to the weight of the PBT, comprises a second polymer selected from the group consisting of polyethyleneglycol terephthalate (PET), PET copolymers, polybutylene naphthanate (PBN), PBN-copolymers, polytrimethylene terephthalate (PTT), PTT-copolymers, polyethyleneglycolnaphthanate (PEN), PEN-copolymers, polycyclohexanedimethylene terephthalate (PCT), PCT-copolymers, aromatic polycarbonates and aromatic polyester carbonates, in an amount of 1-40 wt. %, relative to the total weight of PBT and the second polymer.

It has surprisingly been found that the composition according to the invention, comprising PBT having said low cyclic dimer content in combination with the second polymer in the indicated amount, results in improved demoulding behaviour in critical moulds and/or under critical moulding conditions and allows shorter moulding cycle times compared to the corresponding PBT composition not containing the second polymer, meanwhile retaining the low fogging properties and without significantly reducing the main product characteristics including the mechanical properties

Preferably, the amount of the second polymer is at least 2 wt. %, more preferably at least 4 wt. %, relative to the total weight of PBT and the second polymer. A higher minimal amount for the second copolymer in the composition according to the invention has the advantage that the moulding cycle time can be further reduced.

Also preferably, the amount of the second polymer is at most 25 wt. %, more preferably at most 15 wt. %, relative to the total weight of PBT and the second polymer. The advantage of the composition according to the invention having a lower maximum amount for the second copolymer is that the moulded part has a better surface appearance.

Very good results have been obtained with compositions according to the invention comprising the second polymer in an amount of 5-10 wt. %, relative to the total weight of PBT and the second polymer.

In the context of the present invention polybutylene terephthalate resin (further herein referred to as PBT) is understood to be the condensation product of diols consisting essentially of butanediol and diacids consisting essentially of terephthalic acid. Such a PBT resin is obtainable by direct esterification of butanediol and terephthalic acid or by transesterification of butanediol with the dimethyl ester of terephthalic acid, thus comprising the esterified residues of butanediol and terephthalic acid. The PBT may optionally be a copolymer comprising other components next to the esterified residues of butanediol and terephthalic acid, such as the esterified residues of other diols and dicarboxylic acids, as well as small amounts of polyfunctional alcohols or carboxylic acids. The PBT in the composition according to the invention typically contains at least 70 wt. % of esterified residues of butanediol and terephthalic acid, relative to the weight of the PBT.

Suitable diols that may be comprised in the PBT, are, for example, ethylene glycol, diethylene glycol, propylene glycol, 2,3-pentanediol, neopentylglycol, hexamethylene glycol, and cyclohexanedimethanol.

Suitable dicarboxylic acids are, for example, orthophthalic acid, isophthalic acid, naphthalene dicarboxylic acid, adipic acid, sebacic acid, and succinic acid.

Suitable polyfunctional carboxylic acids that can be used here are, for example, trifunctional carboxylic acids (such as trimesic acid and trimellitic acid) and tetrafunctional carboxylic acids (such as pyromellitic acid).

Suitable polyfunctional alcohols are, for example, triols (such as glycerol, trimethylol ethane, and trimethylol propane), and tetrols (such as pentaerythritol).

Generally, the polyfunctional compounds, if any, are used in very low amounts to give the PBT a little degree of branching.

Preferably, the PBT in the composition according to the invention comprises the other components in an amount of at most 5 wt. %, preferably at most 1 wt. %, even more preferably less than 0.5 wt. %, relative to the weight of the PBT and most preferably no other components at all. A lower amount of other components is preferred in order to better maintain the fast crystallization speed and/or the high heat dimensional stability properties of PBT.

Preferably, the PBT in the composition according to the invention has a residual carboxylic acid content, expressed as the acid number, of at most 50 meq/kg, more preferably at most 40 meq/kg, and even more preferably at most 30 meq/kg relative to the weight of the PBT. The advantage of a polyester composition comprising a PBT with a lower residual carboxylic acid content is that a moulded part made from that composition gives even less fogging.

The PBT that can be used in the composition according to the invention may have a relative viscosity varying over a wide range. Generally the PBT has a relative viscosity, measured on a 0.5 wt % solution in metacresol at 25° C. (and further herein indicated as ηᵣₑₗ), from 1.7 to and including 2.3, though a PBT with a lower as well as with a higher ηᵣₑₗ may be used as well. Preferably, the ηᵣₑₗ of the PBT is at least 1.7, more preferably at least 1.8 and even more preferably at least 1.9. The advantage of a higher ηᵣₑₗ is that a moulded part prepared from the composition has a higher toughness. This is particularly emphasized when the composition does not comprise a reinforcing agent. Also preferably, the ηᵣₑₗ of the PBT is at most 2.3, more preferably at most 2.2 and even more preferably at most 2.1. The advantage of a lower ηᵣₑₗ is that the composition has better processing properties.

The PBT that can be used in the composition according to the invention may be any PBT as described above, provided that either the PBT has a cyclic dimer content of less than 0.35 wt. %, relative to the weight of the PBT, or that the composition comprising the PBT can be converted into a composition with such a low cyclic dimer content. As is found by the inventors, a PBT having a cyclic dimer content of less than 0.35 wt. %, relative to the weight of the PBT, may be prepared, for example, via a melt polymerization process, followed by a heat treatment step.

In a melt polymerization process butanediol and terephthalic acid, or butanediol and the dimethyl ester of terephthalic acid, and optional other diols and/or diacids, and optional polyfunctional alcohols or carboxylic acids are cocondensed above the melt temperature of the PBT. The preparation of PBT by melt polymerization can take place both in a discontinuous (batch) and in a continuous process, and generally comprises two phases, a first phase under atmospheric pressure, followed by a second phase under reduced pressure. Such a polymerization process is well known to the man skilled in the art, and described for example in Encyclopedia of Polymer Science and Engineering, Vol. 12, pages 43-45, Wiley Interscience, New York, 1988 (ISBN 0-471-80994-6) and Kunststoff Handbuch 3/1, Technische Thermoplaste, Polycarbonate, Polyacetale, Polyester and Celluloseester, page 22-23, Hanser Verlag, Munchen, 1992 (ISBN 3-446-16368-9).

Such a PBT prepared by melt polymerisation generally comprises about 0.45 wt. % cyclic dimer relative to the weight of the PBT, as is observed during the experimental work to arrive at the present invention. To achieve a cyclic dimer content of less than 0.35 wt. %, relative to the weight of the PBT, the PBT obtained by melt polymerisation may, for example, be subjected to a heat treatment wherein the PBT is heated in solid form in an inert gas atmosphere to a temperature between 150° C. and said melting temperature, and maintained at a temperature within 150° C. and said melting temperature for a time sufficiently long to attain the indicated low level of cyclic dimer content.

Preferably, the cyclic dimer content preferably in the PBT is less than 0.30 wt. %, more preferably less than 0.25 wt. %, and most preferably less than 0.20 wt. % relative to the weight of the PBT. The advantage of such a lower cyclic dimer content is that fogging of parts made of the PBT composition is even further reduced. Such a lower cyclic dimer content can be achieved by applying a longer time and/or using a higher temperature in the heat treatment step.

In the context of the invention, an inert gas atmosphere is understood to be an atmosphere comprising a very low amount of oxygen, which amount does not give rise, or not in a significant extent, to degradation of the PBT under the temperature conditions applied to the PBT. Generally, such an inert gas atmosphere comprises less than 0.1 wt. % oxygen, preferably less than 0.02 wt. % oxygen, and more preferably less than 0.01 wt. % oxygen, relative to the weight of the gas atmosphere. Most preferably the inert gas is free of oxygen.

In the context of the present invention polyethylene terephthalate resin (further herein referred to as PET) is understood to be the condensation product of ethanediol and terephthalic acid. Such a PET resin is obtainable by direct esterification of ethanediol and terephthalic acid or by transesterification of ethanediol with the dimethyl ester of terephthalic acid, thus comprising the esterified residues of ethanediol and terephthalic acid.

A PET copolymer is herein understood to be a polyester copolymer comprising other components next to the esterified residues of ethyleneglycol and terephthalic acid, such as the esterified residues of other diols and dicarboxylic acids, as well as small amounts of polyfunctional alcohols or carboxylic acids. The PET copolymer in the composition according to the invention preferably contains at least 50 wt. %, and more preferably at least 75 wt. %, of esterified residues of ethanediol and terephthalic acid, relative to the weight of the PET copolymer.

Suitable diols that may be comprised in the PET copolymer, are, for example, butanediol, diethylene glycol, propylene glycol, 2,3-pentanediol, neopentylglycol, hexamethylene glycol, and cyclohexanedimethanol.

Suitable dicarboxylic acids are, for example, orthophthalic acid, isophthalic acid, naphthalene dicarboxylic acid, adipic acid, sebacic acid, and succinic acid.

Suitable polyfunctional carboxylic acids that can be used here are, for example, trifunctional carboxylic acids (such as trimesic acid and trimellitic acid) and tetrafunctional carboxylic acids (such as pyromellitic acid).

Suitable polyfunctional alcohols are, for example, triols (such as glycerol, trimethylol ethane, and trimethylol propane), and tetrols (such as pentaerythritol).

Generally, the polyfunctional compounds, if any, are used in very low amounts to give the PBT a little degree of branching.

Preferably, the PET copolymer in the composition according to the invention comprises the other components in an amount of at most 5 wt. %, preferably at most 1 wt. %, even more preferably less than 0.5 wt. %, relative to the weight of the PBT and most preferably no other components at all. A lower amount of other components is preferred in order to better maintain the fast crystallization speed and/or the high heat dimensional stability properties of PBT.

In the same way as for PET, in the context of the present invention polybutylene naphthanate (further herein referred to as PBN), polytrimethylene terephthalate (further herein referred to as PTT), polyethyleneglycolnaphthanate (further herein referred to as PEN) and polycyclohexanedimethylene terephthalate (further herein referred to as PCT), are understood to be respectively the condensation product of butanediol and naphthalene dicarboxylic acid, trimethylene glycol and terephthalic acid, ethylene glycol and naphthalene dicarboxylic acid, and cyclohexanedimethylene glucol and terephthalic acid.

In the same way as for the PET copolymers, a PBN copolymer, a PTT-copolymer, a PEN copolymer and a PCT copolymer are herein understood to be a polyester copolymer comprising other components next to the esterified residues of diol and dicarboxylic acid used for the base polymers PBN, respectively PTT, PEN and PCT as described here above.

The other components that can be comprised in these copolymers, include esterified residues of other diols and dicarboxylic acids, as well as small amounts of polyfunctional alcohols or polyfunctional carboxylic acids.

Suitable diols, diocarboxylic acids, polyfunctional alcohols and polyfunctional carboxylic acids that can be present in the PBN-, PTT-, PEN- and PCT-copolymers include the same components as mentioned above for the PET-copolymer and include ethylene glycol (for the PBN-, PTT- and PCT-copolymers) and terephthalic acid (for the PBN- and PEN-copolymers).

The PBN copolymer, PTT-copolymer, PEN copolymer and PCT copolymer in the composition according to the invention contain preferably at least 50 wt. %, and more preferably at least 75 wt. %, of esterified residues of diol and dicarboylic acid used for the base polymers PBN, PTT, PEN and PCT, respectively, relative to the weight of the copolymer.

As the aromatic polycarbonate in the composition according to the invention, in principle, any known aromatic polycarbonate may be used. Suitable aromatic polycarbonates in this composition are polycarbonates made from at least one dihydric phenol and a carbonate precursor, for example by using an interfacial polymerisation process.

Suitable dihydric phenols that may be applied are compounds with one or more aromatic rings containing two hydroxyl groups, each directly attached to a carbon atom of an aromatic ring. Examples of such compounds include
4,4′-dihydroxybiphenyl,2,2-bis(4-hydroxyphenyl)propane (bisphenol-A),
2,2-bis(4-hydroxy-3-methylphenyl)propane,
2,2-bis-(3-chloro-4-hydroxyphenyl)-propane,
2,2-bis-(3,5-dimethyl-4-hydroxyphenyl)-propane,
2,4-bis-(4-hydroxyphenyl)-2-methylbutane,
2,4-bis-(3,5-dimethyl-4-hydroxyphenyl)-2-methylbutane,
4,4-bis(4-hydroxyphenyl)heptane, bis-(3,5-dimethyl-4-hydroxyphfenyl)-methane,
1,1-bis-(4-hydroxyphenyl)-cyclohexane,
1,1-bis-(3,5-dimethyl-4-hydroxyphenyl)-cyclohexane,
2,2-(3,5,3′,5′-tetrachloro-4,4′-dihydroxybiphenyl)propane,
2,2-(3,5,3′,5′-tetrabromo-4,4′-dihydroxybiphenyl)propane,
(3,3′-dichloro-4,4′-dihydroxyphenyl)methane,
bis-(3,5-dimethyl-4-hydroxyphenyl)-sulfone, bis-4-hydroxyphenylsulfone,
bis-4-hydroxyphenylsulfide.

The carbonate precursor can be a carbonyl halogenide, a halogen formiate or a carbonate ester. Examples of carbonyl halogenides include carbonyl chloride and carbonyl bromide. Examples of suitable halogen formiates are bis-halogen formiates of dihydric phenols like hydrochinon or of glycols like ethylene glycol. Examples of suitable carbonate esters include biphenyl carbonate, di(chlorophenyl)carbonate, di(bromophenyl)carbonate, di(alkylphenyl)carbonate, phenyltolyl carbonate and mixtures thereof. Although other carbonate precursors may be used as well, carbonylhalogenides and especially carbonylchloride, better known as phosgene, are preferred.

The aromatic polycarbonates in the composition according to the invention may be produced from said compounds with known methods of preparation. In general, also a catalyst, an acid acceptor, and a compound for controlling the molar mass of the polycarbonate are used.

Examples of a catalyst that may be used include tertiary amines like triethyl amine, tripropyl amine and N,N-dimethyl aniline, quaternary ammonium compounds like tetraethylammonium bromide en quaternary phosphonium compounds such as methyltriphenyl phosphoniumbromide.

Examples of suitable acid acceptors include organic compounds like pyridine, triethyl amine, dimethyl aniline. Examples of inorganic acid acceptors are hydroxides, carbonates, bicarbonates and phosphates of an alkali- or earthalkali metal.

Examples of compounds that can be used for controlling the molecular mass include monohydric phenols like phenol, p-alkylphenols, para-bromophenol and secondary amines.

Within the definition of polycarbonate are also copolycarbonates made from at least two dihydric phenols and copolyester-carbonates, that are copolymers made from a dihydric phenol, a dicarboxylic acid and a carbonate precursor.

Such aromatic polycarbonates, and their preparation and properties have been extensively described in for example Encycl. Polym. Sci. Eng., 11, p. 648-718 (Wiley, New York, 1988); or in Kunststoff Handbuch, 3/1, p. 117-297 (Hanser Verlag, München, 1992).

In a special embodiment, the composition according to the invention contains a PET or a polycarbonate made from bisphenol-A and phosgene, and optionally minor amounts of other compounds with one, two, or more reactive groups, the latter compounds as comonomers, for example to affect the melt viscosity of the polymer. Such polymers, often referred to as bisphenol-A polycarbonate, or even simply polycarbonate (PC), are commercially available.

Aromatic polyester carbonates (further herein referred to as APEC), are herein understood to be polymers consisting of ester units derived from aromaticcarboxylic acids and aromatic alcohols and carbonate units derived from as aromatic alcohols and a carbonate or carbonate precursor

As the aromatic polyester carbonates in the composition according to the invention, in principle, any known aromatic polyester polycarbonate may be used. Suitable aromatic polycarbonates in this composition are polycarbonates made from at least one dihydric phenol, a carbonate precursor and an aromatic ester precursor for example by using an interfacial polymerisation process.

Suitable aromatic precursors that may be employed are compounds with one or more aromatic rings containing two acid chloride groups, each directly attached to a carbon of an aromatic ring. Examples of such compounds include isophthalic acid dichloride and terephthalic acid dichloride.

Suitable dihydric phenols and suitable carbonate precursors are the same as described above for the aromatic polycarbonates.

The aromatic polyester carbonates in the composition according to the invention may be produced from said compounds with known methods of preparation. In general, also a catalyst, an acid acceptor, and a compound for controlling the molar mass of the polycarbonate are used. For the preparation of aromatic polyester carbonates the same methods and the same catalysts, acid acceptors, and compounds for controlling the molar mass of the polyester carbonate may be used as described herein above for the aromatic polycarbonate.

In a special embodiment, the composition according to the invention contains an APEC made form bisphenol-A, phosgene, isophthalic acid dichloride and terephthalic acid dichloride.

The second polymer in the composition according to the invention may also be a copolymer of PET, PBN, PTT, PEN, aromatic polycarbonate and/or aromatic polyester carbonate.

In a preferred embodiment of the invention the second polymer is selected from the group consisting of PET, PET-copolymers and aromatic polycarbonate, more preferably the second polymer is PET or PC.

In the composition according to the invention the cyclic dimer content preferably is less than 0.30 wt. %, more preferably less than 0.25 wt. %, and most preferably less than 0.20 wt. % relative to the weight of the PBT. The advantage of a lower cyclic dimer content is that fogging of parts made of the composition is even further reduced.

The composition according to the invention may further comprise, next to the PBT and the second polymer, any customary additive or additives. Preferably, this additive does not comprise solvents, is not itself a volatile, low molecular weight, material, and does not decompose, or not to such an extent, to create fogging problems or mechanical loss problems under use conditions at elevated temperature to which a part made form the inventive composition is exposed.

Suitable additives, that can be used in the composition according to the invention are, for example, inorganic fillers, reinforcing agents, pigments, flame retardants, stabilizers, processing aids, impact modifiers, transesterification inhibitors and nucleating agents. The choice of additive, or additives, will depend on the intended application of the moulded part and on the specific properties required for that part, and can easily be chosen by the man skilled in the art of preparing compositions for making moulded parts.

The inorganic filler can be any filler that is known to the skilled man in the art of making polyester compounds. Suitable inorganic fillers are, for example, mineral fillers, such as talcum and calcium carbonate.

Suitable reinforcing agents are, for example, glass fibres, carbon fibres, glass pearls and nanofillers.

Inorganic fillers and/or reinforcing agents are advantageously used in compositions according to the invention for preparing moulded parts with improved dimensional stability at elevated temperature and/or improved mechanical properties.

Suitable pigments are, for example, titanium dioxide and carbon black.

Suitable flame retardants are, for example, halogenated resins and melamine polyphosphates.

Suitable stabilizers are, for example, oligomeric antioxidants and UV-absorbers.

The composition according to the invention may optionally also comprise polymers different from PBT and the second polymer, which polymers will be denoted as further polymers. These further polymers may be present for particular purposes, such as carrier polymers in pigment concentrations, for impact modification and lubrication. Typically, such further polymers will be present only in limited amount.

Preferably, the further polymers are present in an amount of at most 10 wt. %, more preferably at most 5 wt. %, relative to the total weight of the composition.

Suitable impact modifiers are, for example, functionalized polyethylene rubbers and elastomers such as copolyetheresters.

Suitable processing aids are, for example, lubricants, also known as mould release agents, such as polyethylene waxes. ester based waxes, like montanic waxes and stearate waxes, (e.g. pentaerytrytoltetrasterate), and carnauba waxes.

The amount of lubricant in the composition according to the invention is generally at most 0.5 wt. %, relative to the weight of the composition. Preferably, the composition according to the invention comprises at most 0.30 wt. %, more preferably at most 0.20 wt. % of lubricant, relative to the weight of the composition. The advantage of the composition comprising a lower wt % of lubricant is an even better fogging behaviour.

In a preferred embodiment of the invention, the composition comprises a lubricant with a weight loss factor of at most 1 wt. %, more preferably at most 0.5 wt. %, and even more preferably at most 0.2 wt. %, relative to the weight of the lubricant. The weight loss factor is defined as the weight loss, relative to the initial weight, determined by isothermal thermogravimetric analysis (TGA) at 160° C. under nitrogen after 4 hours. It has been found, that despite the low amount of lubricant generally used in the composition, a lubricant with a low weight loss factor can already be critical for the fogging behaviour of the compound, and that the fogging behaviour can be further improved by using a lubricant with lower weight loss factor.

Suitable transesterification inhibitors are, for example, inorganic pyrophosphates, such as sodium pyrophosphate (Na₂H₂P₂O), inorganic phosphates having at least two acid hydrogen atoms, such as mono zinc dihydrogen phosphate (Zn(H₂PO₄)₂) and mono calcium dihydrogen phosphate (Ca(H₂PO₄)₂), inorganic phosphates with crystal water, such as zinc phosphate (Zn(PO₄)₂.2H₂O) and trisodium phosphate (Na₃PO₄.6H₂O) and mixtures of these phosphates.

Suitable nucleating agents are, for example, talcum, sodium benzoate, TiO₂, Fe₂O₃ and barium sulphate. Nucleating agents are considered herein additives that enhance the crystallization rate of PBT. The crystallisation rate can be measured by standard methods such as differential scanning calorimetry (DSC).

Preferably, the composition according to the invention comprises at most 2 wt. %, more preferably at most 1 wt. %, still more preferably at most 0.5 wt. %, relative to the total weight of the composition, of nucleating agent. Most preferably the composition according to the invention comprises less than 0.1 wt. % nucleating agent relative to the total weight of the composition, or does not comprise any nucleating agent at all. The advantage of a lower amount of nucleating in the composition according to the invention is that the moulding cycle time is even shorter.

Preferably, the additive in the composition, when present in the composition in the form of discrete solid particles, has an average particle size of less then 10 μm, more preferably less than 2 μm, even more preferably less than 1 μm and most preferably less than 0.5 μm. The particle size may be as low as 10 Å, or even lower, as can be the case with nanofillers. The advantage of the composition according to the invention comprising an additive with a smaller particle size is that it can be used for preparing moulded parts with a higher surface gloss.

For applications requiring very high gloss surfaces, the composition according to the invention preferably does not comprise any additive in the form of discrete particles.

In a preferred embodiment of the invention, the composition consists of
a) PBT with a cyclic dimer content of less than 0.35 wt. %, relative to the weight of the PBT,
b) a second polymer, selected from the group consisting of polyethyleneglycol terephthalate (PET), PET copolymers, polybutylene naphthanate (PBN), PBN-copolymers, polytrimethylene terephthalate (PTT), PTT-copolymers, polyethyleneglycolnaphthanate (PEN), PEN-copolymers, polycyclohexanedimethylene terephthalate (PCT), PCT-copolymers, aromatic polycarbonates and aromatic polyester carbonates (APEC), in an amount of 1-40 wt. %, relative to the total weight of PBT and the second polymer, and, optionally,
c) a lubricant,
d) a transesterification inhibitor, and/or
e) an additive, or additives, having the form of discrete solid particles, preferably with a weight average particle size of less than 10 μm.

In a more preferred embodiment of the invention, the composition consists of
a) PBT with a cyclic dimer content of less than 0.35 wt. %, relative to the weight of the PBT,
b) 2-25 wt. % of a second polymer, selected from the group consisting of polyethyleneglycol terephthalate (PET), PET copolymers, and aromatic polycarbonate, relative to the total weight of PBT and second polymer
c) at most 0.3 wt. % of lubricant,
d) 0-0.2 wt. % transesterification inhibitor,
e) 0-1.0 wt. % of a pigment,
wherein the weight % of c), d) and e) are relative to the total weight of the composition.

The polyester composition according to the invention comprising the PBT with a cyclic dimer content of less than 0.35 wt. % and the second polymer can be obtained by mixing or blending the various components applying known techniques. This mixing may be a ‘dry’ blending operation, wherein the various components are mixed below the melt/processing temperatures of the PBT and second polymer, or a melt blending process wherein the components, optionally pre/blended, are mixed at suitable melt/processing temperatures, e.g. in a single/or twin/screw extruder. Also a combination of dry/and melt/blending can be applied.

The invention also relates to the use of a polyester composition according to the invention in a process for the preparation of a moulded part, in particular the use in a moulding process comprising injection moulding of the inventive composition to form the moulded part, and to a moulded part prepared from a polyester composition according to the invention.

The advantage of such a process, wherein the composition according to the invention is used is that short cycle times can be achieved even in case of critical moulding conditions, which cycle times are shorter than obtained with corresponding polyester compositions not comprising the second polymer under the same critical moulding conditions.

The advantage of such a moulded part is, that it gives less fogging when used in an application wherein the part is subject to heating under normal use conditions, compared to a moulded part made of a standard PBT containing composition.

In a special embodiment the moulded part is a part for a headlight for a motor vehicle, such as a bezel or a reflector, or a lamp base for an energy saving lamp.

The invention further relates to the use of a moulded part according to the invention in assembling a mirror optic system, and to a mirror optic system comprising a moulded part according to the invention. In a particular embodiment of the invention, the mirror optic system is a headlight for a motor vehicle or a garden reflector lamp.

The invention also relates to a motor vehicle comprising a headlight according the invention, in particular a truck, a passenger's car or a motorbike. The advantage of a motor vehicle comprising a headlight according the invention is that during the life time of the motor vehicle, less fogging of the headlight occurs, as a result of which the yield of the light is better retained and the road-users remain better secured, compared to a motor vehicle comprising a headlight made of a standard PBT containing composition.

The invention is further illustrated with the following examples and comparative experiments.

Analytical Methods

Cyclic dimer content: An amount of PBT or PBT containing composition of 200-300 mg was dissolved at room temperature in 10 ml of hexafluoroisopropanol. This solution was analysed by high performance liquid chromatography. The column used was a ZORBAC SB C18 (250*3 mm). A gradient with 10 mM H₃PO₄ and acetonitril at 40° C. and flow of 0.5 ml/min was applied; acetonitril varied from 40% to 100% during elution. Detection was done with a diode array detector set at 238 nm

Relative viscosity (ηᵣₑₗ): method based on ISO 3007, third edition 1994-09-01; The measurement was done by measuring the flow time of a PBT solution in metacresol, 0.5 wt. %, at 25° C. in an Ubbelohde tube and dividing the resulting time by the time measured for pure metacresol.

Carboxylic acid number: determined by photometric titration of a solution of PBT in orthocresol/chloroform mixture (70:30 weight by weight) with 0.05 KOH in ethanol, using bromocresolgreen as the indicator.

Weight loss factor: a sample of ca. 10 mg of lubricant was weighed and placed in a thermogravimetric analysis apparatus (TGA)(PERKIN ELMER TGA 7). The TGA measurement was carried out in isothermal mode in helium atmosphere at a temperature of 160° C. during 4 hours. At the end of that period the weight loss was measured in weight % relative to the initial weight and reported as the weight loss factor.

Materials

| | |
|---|---|
| 1,4-Butanediol: | Polymerization grade |
| Dimethylterephthalate: | Polymerization grade |
| Lubricant | PARACERA C40 (ex Paramelt B.V., |
| | The Netherlands) |
| | Carnaubawax (weight loss factor 0.30 wt. %) |
| Pigment concentrate: | Carbon black concentrate, 25 wt. %, in PBT |
| PET | Polyethyleneglycol terephthalate, relative |
| | viscosity measured in m-cresol 1.60 |
| NaH₂PO₄•2H₂O | Sodium dihydrogen phosphate dihydrate, |
| | transesterification inhibitor |

Preparation of PBT by Melt-Polymerization

A 20 L reactor equipped with stirrer and condenser was charged with 7060 g dimethylterephthalate, 4100 g 1,4-butanediol and 85.0 g of a titanium tetra n-butoxide catalyst solution in 1,4-butanediol (40 mg catalyst per gram solution). After 3 times flushing of the reactor with nitrogen, the reactor content was heated gradually under stirring and atmospheric pressure within one hour to a temperature of 150° C., kept at this temperature for half an hour, and subsequently heated further within 2 hours to a temperature of 235° C. The thus obtained transesterified product was then further polymerised at 240° C. under reduced pressure (50-100 Pa) for 120 minutes at a stirring speed of 20 RPM. The polymerised product was extruded from the reactor, under nitrogen pressure, in the form of a strand, cooled in water and pelletized in a pelletizer. The ηᵣₑₗ and acid number of the polymer were determined to be 1.85, respectively 18 meq/g. The polymer had a cyclic dimer content of 0.45 wt. %.

### EXAMPLE I

Heat Treatment of the PBT

Heat treatment of the PBT obtained by melt-polymerization was performed on a Rotavapor R 51 from Büchi. A 10 L glass flask was charged with 2 kg PBT granules and vented with pure, dry nitrogen. Then, the pressure was reduced to 100 Pa and the rotating flask was heated in an oil bath. The temperature of the granules was raised to 185° C. This temperature was kept for 5 hours. After this period, the oil bath was taken away and the granules cooled to room temperature. Then the cyclic dimer content and ηᵣₑₗ was measured. The results were respectively ηᵣₑₗ 2.00 and cyclic dimer content 0.28 wt. %.

Preparation of PBT/PET Composition by Compounding

A PBT/PET composition, comprising the 88 wt. % PBT obtained by melt polymerisation and subsequent heat treatment described above, 9.75 wt. % PET, 2 wt. % pigment concentrate, 0.15 wt. % lubricant, and 0.10 wt. % transestererification inhibitor was prepared on a ZSK 30/34 twin-screw extruder ex Werner and Pfleiderer. Barrel temperature was set at 260° C., screwspeed was 325 RPM and yield was 10 kg/hour. Components were dosed to the hopper as a pre-blend. Extruded strands were cooled in water and granulated. The ηᵣₑₗ of the composition was 1.96.

Injection Moulding

The PBT/PET composition described above was injection moulded on an injection moulding machine into a mould using appropriate injection moulding conditions. The cycle time was varied. A criterion was set for a maximum percentage of rejected ill-demoulding parts with respect to deformation and visual aspects (surface quality and mechanical damages).

### COMPARATIVE EXAMPLE A

Preparation of PBT Composition by Compounding

A PBT composition, comprising 97.85 wt. % of the PBT obtained by melt polymerisation, 2.00 wt. % pigment concentrate, and 0.15 wt. % lubricant was prepared on a ZSK 30/34 twin-screw extruder ex Werner and Pfleiderer. Barrel temperature was set at 260° C., screwspeed was 325 RPM and yield was 10 kg/hour. Components were dosed to the hopper as a pre-blend. Extruded strands were cooled in water and granulated.

Heat Treatment

Heat treatment composition of the PBT composition was performed on a Rotavapor R151 from Buchi following the same procedure as applied for Example I. The temperature was kept at 185° C. for 5 hours. After this period, the oil bath was taken away and the granules cooled to room temperature. The cyclic dimer content of the composition was 0.29 wt. % and ηᵣₑₗ was 1.98.

Injection Moulding

The PBT composition obtained after the heat treatment described above was injection moulded in the same way as described for Example I. The same criterion was applied for the maximum number of reject parts

Example I showed a shorter minimum cycle time than Comparative Experiment A. If for Comparative Experiment A the same short cycle time was applied as the minimum cycle time for Example I, there was a larger number of parts that showed damaged sections and/or deformations than was the case for Example I under the same conditions.

1. Thermoplastic polyester composition comprising a polybutylene terephthalate resin (PBT) characterised in that the composition has a cyclic dimer content of less than 0.35 wt. %, relative to the weight of the PBT, and a second polymer selected from the group consisting of polyethyleneglycol terephthalate (PET), PET copolymers, polybutylene naphthanate (PBN), PBN-copolymers, polytrimethylene terephthalate (PTT), PTT-copolymers, polyethyleneglycolnaphthanate (PEN), PEN-copolymers, polycyclohexanedimethylene terephthalate (PCT), PCT-copolymers, aromatic polycarbonates and aromatic polyester carbonates (APEC), in an amount of 1-40 wt. %, relative to the total weight of PBT and the second polymer.

2. Composition according to claim 1, wherein the amount of the second polymer is 2-25 wt. %, relative to the total weight of PBT and the second polymer.

3. Composition according to claim 1, wherein the cyclic dimer content is less than 0.30 wt. %, relative to the weight of the PBT.

4. Composition according to claim 1, wherein the second polymer is PET or bisphenol-A-polycarbonate (PC)

5. Composition according to claim 1, wherein the composition consists of
a) PBT with a cyclic dimer content of less than 0.35 wt. %, relative to the weight of the PBT,
b) a second polymer, selected from the group consisting of polyethyleneglycol terephthalate (PET), PET copolymers, polybutylene naphthanate (PBN), PBN-copolymers, polytrimethylene terephthalate (PTT), PTT-copolymers, polyethyleneglycolnaphthanate (PEN), PEN-copolymers, polycyclohexanedimethylene terephthalate (PCT), PCT-copolymers, aromatic polycarbonates and aromatic polyester carbonates (APEC), in an amount of 1-40 wt. %, relative to the total weight of PBT and the second polymer, and, optionally,
c) a lubricant,
d) a transesterification inhibitor, and/or
e) an additive, or additives, having the form of discrete solid particles, preferably with a weight average particle size of less than 10 μm.

6. Process for preparing a composition according to claim 1 comprising blending a PBT with a cyclic dimer content of less than 0.35 wt. %, relative to the weight of the PBT, a second polymer as defined in claims 1-5, and, optionally, an additive or additives.

7. Use of a polyester composition according to claim 1 for the preparation of a moulded part.

8. Use according to claim 7, wherein the moulded part is a part for a lamp.

9. Moulded part comprising a polyester composition according to claim 1.

10. Moulded part according to claim 9, wherein the moulded part is a bezel for a headlight, a reflector for a headlight or a base for an energy saving lamp.
